(19) United States
(12) Patent Application Publication
(10) Pub. No.: US 2008/0057349 A1
(43) Pub. Date: Mar. 6, 2008

(54) High Performance Perpendicular Media for Magnetic Recording with Optimal Exchange Coupling between Grains of the Media

(75) Inventors: Andreas Klaus Berger, San Jose, CA (US); Hoa Van Do, Fremont, CA (US); Yoshihiro Ikeda, San Jose, CA (US); Byron Hassberg Lengsfield, Gilroy, CA (US); Hal Jervis Rosen, Los Gatos, CA (US); Kentaro Takano, San Jose, CA (US); Min Xiao, Los Gatos, CA (US)

Correspondence Address: BRACEWELL & GIULIANI LLP, P.O. BOX 61389, HOUSTON, TX, 77208-1389, US

(73) Assignee: Hitachi Global Technologies

(21) Appl. No.: 11/470,310

(22) Filed: Sep. 6, 2006

(51) Int. Cl. G11B 5/65

(52) U.S. Cl. 428/836.2

(57) ABSTRACT

A high performance perpendicular media with optimal exchange coupling between grains has improved thermal stability, writeability, and signal-to-noise ratio in a selected range of allowable intergranular exchange between the grains for high performing media. The writeability and byte error rate of a TaOₓ media are demonstrated to be substantially better than that of other designs.

### BACKGROUND OF THE INVENTION

1. Technical Field

The present invention relates in general to magnetic recording media for hard disk drives and, in particular, to an improved system, method, and apparatus for high performance perpendicular media for magnetic recording with optimal exchange coupling between grains of the media. Further described is a method to quantify the exchange coupling between grains of the media.

2. Description of the Related Art

The hard disk drive industry is rapidly moving to perpendicular recording for future high density products, such as those in excess of 100 Gb/in². The transition has been accelerated by the introduction of media formed from the material CoPtCrSiOₓ. Media formed from this material have low noise and high resolution. This media has been designed to have small, well-separated grains with a non-magnetic oxide segregant between the grains of the material to minimize the exchange interaction between the grains. However, it has been predicted theoretically that zero exchange between the grains does not give optimum performance. See, e.g., Z. Jin, X. B. Wang, and H. N. Bertram, IEEE Trans., MAG 39, 2603 (2003).

U.S. Pat. No. 5,679,473, to Murayama, describes oxide containing materials for conventional longitudinal recording media. Thus, the overall structures used, including template layers and crystallographic orientation, are completely different than that for perpendicular recording. For example, in the magnetic recording layer alone, the grains have no specified orientation. The coercive fields of the structures described are around only 2 kOe, and the recording layer is sputtered in an argon/nitrogen sputter gas. The widest ranging materials compositions described in this patent only include Si and Ti-oxide type media layers. However, those are very different layers in an overall very different media structure because it describes non-oriented grains for longitudinal recording applications.

U.S. Pat. No. 6,641,901, to Yoshida, describes a dual magnetic recording layer for the purpose of tuning the intergranular exchange coupling, and specifically states that the coupling strength in the first layer is minimal. In the present approach, dual layer structures are merely used as an illustration that shows the effect of intergranular coupling.

An article in IEEE Transactions of Magnetics, Vol. 39, No.5, September 2003, p2341, discusses intergranular exchange coupling in a perpendicular magnetic recording layer, but (a) the only recording layer material disclosed is CoPtCr-oxide, and (b) no real measurement and optimization of the intergranular coupling is performed. Another article in that same journal (Vol. 40, No.4, July 2004, p2498), discusses oxygen optimization in CoPtCrSi-oxide media. However, the underlayer structure is not discussed (i.e., no complete structure is revealed), and the results are only discussed in the context of processing parameters and not evaluated in terms of the intergranular exchange coupling. Thus, an improved solution for high performance perpendicular media for magnetic recording with optimal exchange coupling between grains of the media would be desirable.

### SUMMARY OF THE INVENTION

One embodiment of a system, method, and apparatus for high performance perpendicular media with optimal exchange coupling between grains has improved thermal stability, writeability, and signal-to-noise ratio (SNR) in a selected range of allowable exchange coupling values between the grains for high performing media. The writeability and byte error rate (BER) of a TaOₓ media is substantially better than that of a SiOₓ media. In one embodiment, a range of suitable intergranular exchange coupling values, such as Hₑₓ=0.20-0.50 Hₖ, is desirable. Also provided is the method used to quantify the exchange coupling value Hₑₓ.

The foregoing and other objects and advantages of the present invention will be apparent to those skilled in the art, in view of the following detailed description of the present invention, taken in conjunction with the appended claims and the accompanying drawings.

### BRIEF DESCRIPTION OF THE DRAWINGS

So that the manner in which the features and advantages of the invention, as well as others which will become apparent are attained and can be understood in more detail, more particular description of the invention briefly summarized above may be had by reference to the embodiment thereof which is illustrated in the appended drawings, which drawings form a part of this specification. It is to be noted, however, that the drawings illustrate only an embodiment of the invention and therefore are not to be considered limiting of its scope as the invention may admit to other equally effective embodiments.

FIG. 1 is a schematic view of a one embodiment of a perpendicular media structure and is constructed in accordance with the present invention;

FIG. 2 depicts plots of magnetization M vs. applied field H loops for various embodiments of the perpendicular media structure of FIG. 1;

FIG. 3 depicts plots of the writeability of various embodiments of the perpendicular media structure of FIG. 1;

FIG. 4 depicts plots of thermal stability for various embodiments of the perpendicular media structure of FIG. 1;

FIG. 5 is a plot of the writeability of different examples of a perpendicular media structure;

FIG. 6 is a plot of the improved BER of different examples of a perpendicular media structure;

FIGS. 7a and 7b are graphs of ΔH(M/Mₛ) for determining values of σHₖ and J_{c};

FIG. 8 is a graph of fit parameter σHₛ for the method to determine Hₑₓ;

FIG. 9 is a calibration curve to determine Hₑₓ from the J_{c} fit parameter

FIG. 10 is a measured hysteresis loop of a media sample;

FIG. 11 is an extracted ΔH (M, ΔM)-data set; and

FIG. 12 is a graph of intrinsic switching field distribution.

### DETAILED DESCRIPTION OF THE INVENTION

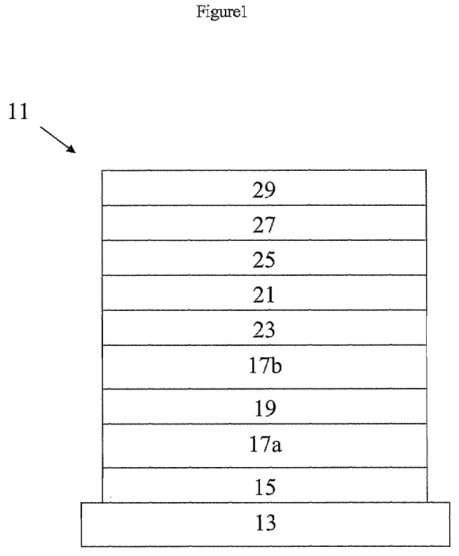

To study the optimum exchange for perpendicular media a model structure was used that allowed the exchange to be changed in a systematic fashion. The media structure is shown in FIG. 1 and depicts a perpendicular structure 11 having soft underlayers, growth layers and a magnetic recording layer. For example, one embodiment of the present invention comprises a non-magnetic substrate 13, an adhesion layer 15, a magnetically soft under layer stack, comprising two soft underlayers 17a, 17b, that are separated by an optional non-magnetic layer 19, which may or may not cause antiferromagnetic interlayer coupling, an optional underlayer structure 23, which may comprise several layers, a magnetic recording layer 21 having a granular structure comprising ferromagnetic crystalline grains surrounded by an oxide grain boundary, a magnetic cap layer 25 (which may or may not be present), a protective layer 27, and a lubricant layer 29. The soft underlayer may be a single layer structure.

Although it does not form a portion of the present invention, FIG. 1 also depicts a capping or cap layer 25 on top of the hard magnetic recording layer 21. The cap layer 25 was chosen to have a large exchange coupling within the layer. Thus, for various thicknesses of the cap layer, a controlled exchange between the grains of the magnetic recording layer 21 (inter-granular exchange) is introduced. Due to the strong inter-layer exchange coupling between the magnetic recording layer 21 and the magnetic cap 25, the combined structure acts as a single layer with modified materials properties. The cap layer 25 itself may comprise multiple layers and is in direct contact (i.e., fully coupled) with the magnetic layer 21, either above it or below it. The materials for the cap layer 25 is a ferromagnetic material such as Co alloys, CoPt alloys, CoPtCr alloys, Fe alloys.

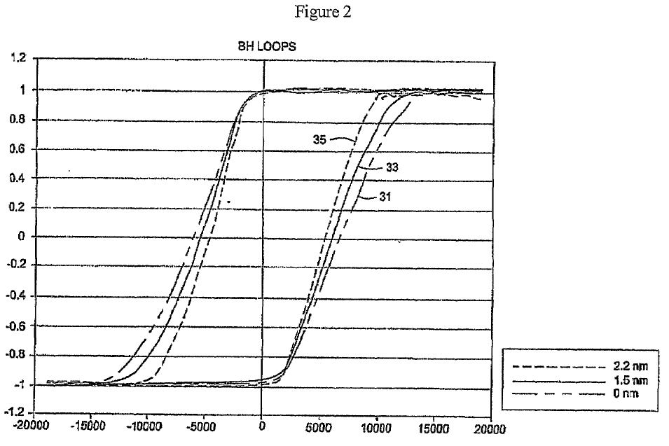

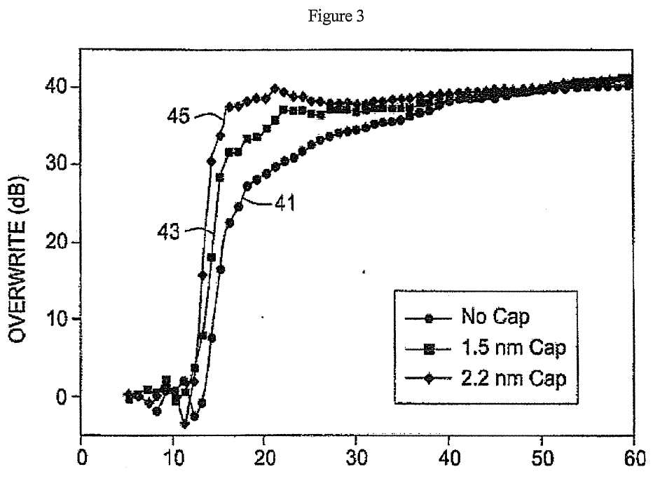

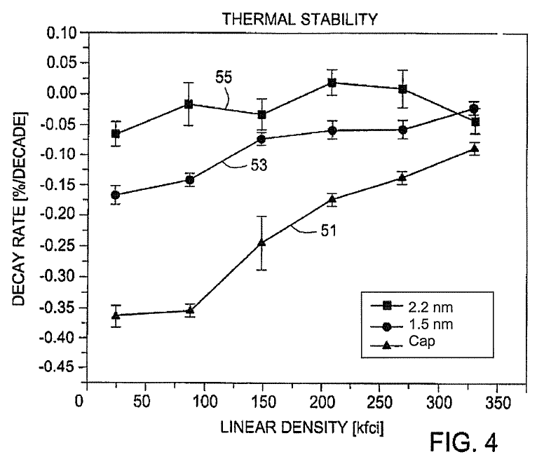

The effects of this inter-granular exchange were studied for different thicknesses of the cap layer 25, including 0, 1.5, and 2.2 nm. The introduction of inter-granular exchange coupling by adding the cap layer sharpens the M vs. H loops 31, 33, 35, respectively, reducing Hc and the closure field as shown in FIG. 2. The reduction in coercivity and closure field leads to substantially improved writeability 41, 43, 45, respectively, as shown in FIG. 3. Along with these improvements in writeability, the thermal stability 51, 53, 55, respectively, is also improved as shown in FIG. 4.

As shown in Table 1, which summarizes the magnetic and recording properties of previously described examples for the perpendicular media test structures, the amount of inter-granular exchange coupling Hex shows significant variation for the samples. These values are determined from ΔH(M)-measurement, which will be discussed subsequently.

TABLE 1

| Cap | | | | | | |
|---|---|---|---|---|---|---|
| Thickness | Hex | Hk | | BER | | Ho |
| (nm) | (kOe) | (kOe) | Hex/Hk(×100%) | 750KBPI) | KuV | (kOe) |
| 0 | 2.1 | 14.1 | 15 | −4.2 | 75 | 11.5 |
| 1.5 | 3.4 | 12.9 | 26 | −4.3 | 81 | 9.5 |
| 2.2 | 5.0 | 12.4 | 40 | −3.6 | 84 | 8.1 |

As the inter-granular exchange coupling is increased from 2.1 kOe to 3.4 kOe in the first two samples, the recording performance as measured by BER remains essentially the same. However, as this quantity is further increased to 5.0 kOe in the third sample, the BER and recording performance degrade substantially. This behavior illustrates a general phenomena for introducing inter-granular exchange into perpendicular media: as this exchange value is increased, the writeability and thermal stability will improve. However, if the inter-granular exchange coupling is increased by too large a factor, the recording performance (e.g., Bit Error Rate (BER)) will degrade. Thus, there is an optimum range of inter-granular exchange coupling for perpendicular media.

As shown in Table 2, which summarizes the performance of various examples of single layer perpendicular recording media, the inter-granular exchange coupling with a TaOₓ segregant media is larger than for a SiOₓ segregant media. The TaOₓ media has significantly smaller grains yet is more thermally stable than the SiO_{X} media. As shown in the previous test experiment using capped media structures, this stabilization can be attributed to the increased level of inter-granular exchange coupling in the Ta-oxide media. The CoPtCrSiOx media was made with a target composition of: (Co 65 at. % Cr 17 at. % Pt 18 at. %) 92 mol % (SiO) 8 mol %. The CoPtCrTaOx media was made with a target composition of: (Co 66 at. % Cr 18 at. % Pt 16 at. %) 97.5 mol % (TaO) 2.5 mol %.

TABLE 2

| | Grain | Grain | | | Thermal Decay |
|---|---|---|---|---|---|
| | size | Separation | Hex/Hk | | %/decade @ 25 |
| Sample | nm | nm | (×100%) | KuV/kT | kfci |
| CoPtCrSiOx | 5.8 | 1.3 | 14 | 57 | 3.5 |
| CoPtCrTaOx | 5.1 | 1.0 | 21 | 59 | 0.6 |

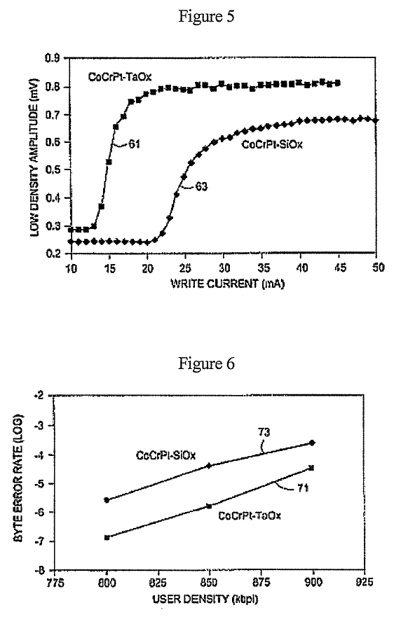

FIGS. 5 and 6 depict a comparison of the recording performance of these two types of media. As expected, the writeability 61 (FIG. 5) of the TaOₓ media is substantially better than the writeability 63 of the SiOₓ media. The BER 71 (FIG. 6) also is much better for the TaOₓ media than the BER 73 of SiOₓ media, which is likely associated with the smaller thermally stable grains of that media and the elevated level of inter-granular exchange coupling. The enhanced exchange coupling in this media enables the fabrication of smaller grains and the resulting improvement in media performance without compromising thermal stability.

Characterization quantities for magnetic recording materials include the following. Magnetic grains have an easy axis, along which the magnetization aligns itself when no external field H is applied. The anisotropy field Hk is the field equivalent of the orientational free energy gained by orienting the magnetization along the magnetic easy axis. It is equal to the applied magnetic field H necessary along the easy axis to reverse the magnetization of a grain. The magnetic grains in recording media have two interactions: (i) the dipole-dipole interaction, which is the commonly known magnetic interaction of bar magnets, for example. This interaction is quite strong since the magnets are perpendicularly magnetized, but generally smaller than Hk to allow for stable magnetic states with perpendicular orientation of the magnetization; (ii) intergranular exchange interaction. In general ferromagnetic materials, spins of electrons in overlapping orbitals tend to align parallel due to the exchange interaction causing ferromagnetism, i.e. the net alignment of electron spin moments. In general, magnetic recording media are engineered in such a way that this exchange interaction is suppressed within the grain boundary, which enables each grain to have an independent magnetic state and allows arbitrary positioning of magnetic bit pattern. Within each grain, the exchange interaction is very strong (e.g., typically of the order of 10+Hₖ). For perpendicular recording media, however, reducing the inter-granular coupling to zero is not optimal, which is demonstrated herein. The quantity used to describe the inter-granular interaction is the exchange field Hₑₓ, which is the field equivalent that would produce the same energy reduction as the inter-granular exchange interaction in a fully magnetized or aligned magnetic state:

exchange energy E (for grain i)=−sum of index j (J Mᵢ Mⱼ)=−MᵢHₑₓ.

The capped structure illustrated in FIG. 1 is for illustration purposes only and allows for the testing of a series of disks by changing only the intergranular exchange. In one embodiment, optimal performance was observed at Hₑₓ (exchange field)=0.26 Hₖ (anisotropy field). This knowledge was used to make overall optimized recording layers that have a precise amount of intergranular exchange coupling.

The optimal intergranular exchange coupling with respect to the recording performance also depends on the exact recording geometry (i.e., the recording head). Therefore, a range of suitable intergranular exchange coupling values, such as Hₑₓ=0.10-0.80 Hₖ, is desirable. In another embodiment, a range of 20% to 50% Hₖ is used.

In practice, one embodiment of the present invention comprises all of the elements of FIG. 1 except for the cap layer. The magnetic recording medium for a perpendicular recording system comprises a non-magnetic substrate, an adhesion layer, a magnetically soft under layer, an underlayer, a magnetic layer having a granular structure comprising ferromagnetic crystalline grains surrounded by an oxide grain boundary, a protective layer, and a lubricant layer. In one embodiment, the protective layer and the lubricant layer are nonmagnetic and provide oxidation protection. In another embodiment, the composition of the magnetic layer is Co_{A}Pt_{B}Cr_{C}M_{D}O_{X} where M is an oxide forming element, where an amount of exchange field, Hex, between the ferromagnetic crystalline grains is 10 to 80% of Hₖ, and where Hₖ is the magnetic anisotropy field of the magnetic grains. The M component of the magnetic layer may comprise, for example, Si, Ta, Ti, Nb, or B. In other embodiments, one or more of the layers of the magnetic recording medium comprises a plurality of layers each.

Magnetic exchange field measurements of a media are conducted as follows in a three step process. First, ΔH(M) is measured. Second, the results of measurement are used to fit data to obtain parameters σHₖ and J_{c}. Third, the function J_{c}f(M, σHₖ, Hₑₓ/Hₖ) is used to determine Hₑₓ/Hₖ, i.e. the ratio of the inter-granular exchange coupling field Hₑₓ to the anisotropy field of the media layer Hₖ.

ΔH(M) is measured as described in ΔH (M, ΔM) Method for Determination of Intrinsic Switching Field Distributions in Perpendicular Media, Berger, et al., IEEE Transactions on Magnetics, Vol. 41, No. 10, October 2005. The paper describes a method of determining ΔH (M, ΔM)=g(σHₖ), where M is the magnetization value of the media and σHₖ is the standard deviation of the Hₖ-distribution. This data analysis is exact as long as the “mean-field” approximation of the grain-to-grain interactions is appropriate.

In an extension of the ΔH (M, ΔM)-methodology, deviations from the “mean-field” approximation can be included in the data analysis. These deviations are dominated by the inter-granular exchange interactions, i.e. the inter-granular exchange coupling field Hₑₓ, which in turn can be quantified by proper analysis of the “non mean-field behavior”. So, in the second step of the data analysis, the formula to ΔH (M, ΔM)=g(σHₖ)+h(J_{c}) is utilized with h(J_{c}) being the “non mean-field” correction term. With the use of fitting, once ΔH (M, ΔM), the field difference curves, is determined, values for σHₖ and J_{c} can be obtained. Crucial element for this approach is the use of an appropriate functional form for h(J_{c}). Specifically, we use the expression

$$h ( {J}_{C} ) = {I}^{- 1} ( \frac{1 - M + {J}_{C} \cdot ( 1 - M ) \cdot Δ M}{2} ) - {I}^{- 1} ( \frac{1 - M}{2} )$$

in connection with the general formulation of the ΔH-method according to the above paper by Berger et al., i.e. for

$$g ( σ {H}_{K} ) = {I}^{- 1} [ \frac{1 - M}{2} ] - {I}^{- 1} [ \frac{1 - ( M + Δ M )}{2} ]$$

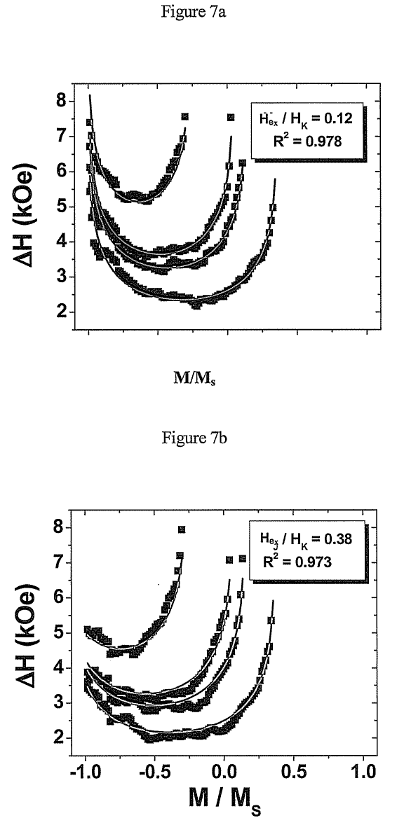

to determine the values for σHₖ and J_{c}. FIGS. 7a and 7b show graphs of ΔH (M, ΔM) used to determine the values of σHₖ and J_{c}.

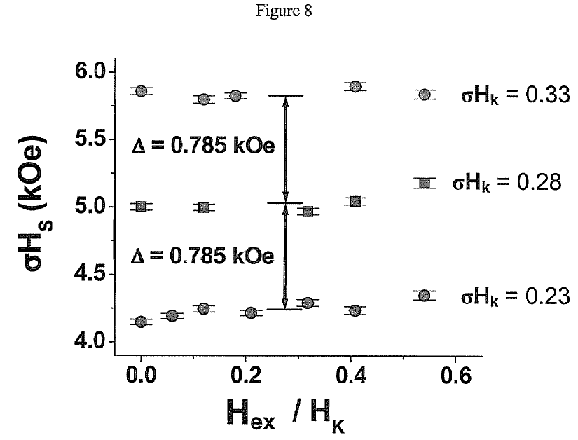

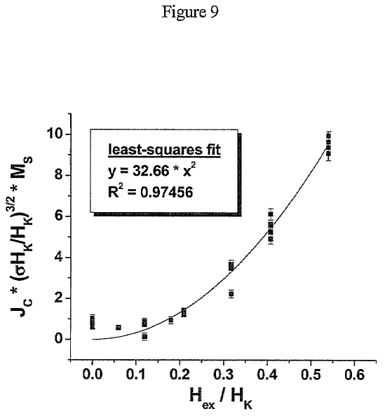

FIG. 8 demonstrate the robustness of this method and the suitability of the “non mean-field” correction factor, verified by means of micromagnetic calculations. FIG. 8 shows the resulting fit parameter, called σHₛ to distinguish it from the micromagnetic input parameter σHₖ, as a function of the inter-granular exchange coupling field Hₑₓ and three different values of σHₖ. Since σHₛ follows σHₖ with better than 1% precision and is independent from Hₑₓ, the suitability of the method in terms of σHₖ determination is demonstrated. To insure the viability of Hₑₓ measurements, it needs to be demonstrated that the fit-parameter J_{c} has a functional relation with the inter-granular exchange coupling field Hₑₓ, that can be calibrated. This is demonstrated in FIG. 9, where this calibration curve is shown for many different input parameters of the micromagnetic calculation.

Once σHₖ and J_{c} are obtained, the next step is to determine the exchange coupling Hₑₓ/Hₖ with the use of the function J_{c}=(M, σHₖ, Hₑₓ/Hₖ). FIG. 9 shows the calibration curve to determine Hₑₓ/Hₖ. σHₖ may also be determined by other means, such as transverse susceptibility measurements.

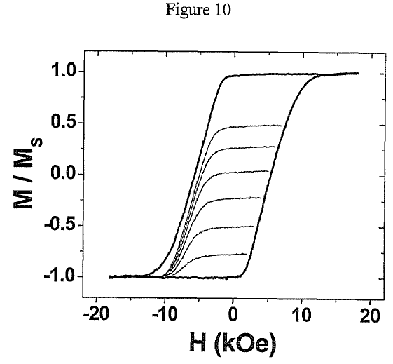

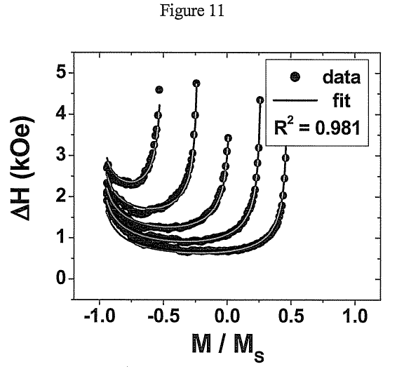

An example of the method for real experimental data is shown in FIGS. 10-12. FIG. 10 shows the measured major hysteresis loop of a media sample in addition to multiple recoil loops. Hereby, the SUL-background was subtracted out from all data sets. From the multiple recoil loops of FIG. 10, a ΔH (M, ΔM)-data set is extracted, which is shown in FIG. 11. This data set is the fitted by the above derived function:

$$\begin{matrix}Δ H ( M , Δ M ) = {I}^{- 1} [ \frac{1 - M}{2} ] - {I}^{- 1} [ \frac{1 - ( M + Δ M )}{2} ] + h ( {J}_{C} ) \\ with & ( 1 ) \\ {I}^{- 1} ( \frac{1 - M}{2} ) = - \sqrt{2} \cdot σ \cdot \frac{{erf}^{- 1} ( M )}{1 + α \cdot M} - \frac{w}{2} \cdot \frac{tan ( \frac{π}{2} M )}{1 + β \cdot M} \\ and & ( 2 ) \\ h ( {J}_{C} ) = {I}^{- 1} ( \frac{1 - M + {J}_{C} \cdot ( 1 - M ) \cdot Δ M}{2} ) - {I}^{- 1} ( \frac{1 - M}{2} ) & ( 3 )\end{matrix}$$

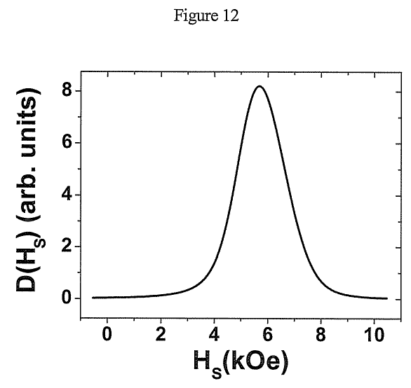

with σ, α, β, w and Jc as fit parameters. The fit, which is generally of excellent quality, is also shown in FIG. 11. The fit parameters σ, α, β, w then allow the reconstruction of the intrinsic switching field distribution D(H_{S}) (shown in FIG. 12) by means of numerical inversion as discussed in the above mentioned paper by Berger et al. From this switching field distribution, one can then determine the standard deviation σHₖ, which in connection with J_{c} and the calibration curve FIG. 9 allows the measurements of Hex/Hk, the ratio of inter-granular exchange coupling field over anisotropy field for the recording layer. If α and β are non-zero, the anisotropy field distribution will be asymmetric. Further, changing α and β alters the shape of the anisotropy field distribution.

While the invention has been shown or described in only some of its forms, it should be apparent to those skilled in the art that it is not so limited, but is susceptible to various changes without departing from the scope of the invention.

What is claimed is:

1. A magnetic recording medium for a perpendicular recording system, comprising:
a non-magnetic substrate and a magnetic layer having a granular structure comprising ferromagnetic crystalline grains surrounded by an oxide grain boundary, where an amount of exchange field, Hₑₓ, between the ferromagnetic crystalline grains is 10% to 80% of Hₖ, and where Hₖ is a magnetic anisotropy field of the magnetic grains.

2. A magnetic recording medium according to claim 1 wherein the composition of the magnetic layer being Co_{A}Pt_{B}Cr_{C}M_{D}O_{X} where M is an oxide forming element.

3. A magnetic recording medium according to claim 2 wherein the magnetic layer is Co_{A}Pt_{B}Cr_{C}Si_{D}O_{X}.

4. A magnetic recording medium according to claim 2 wherein the magnetic layer is Co_{A}Pt_{B}Cr_{C}Ta_{D}O_{X}.

5. A magnetic recording medium according to claim 2 wherein the magnetic layer is Co_{A}Pt_{B}Cr_{C}Ti_{D}O_{X}.

6. A magnetic recording medium according to claim 2 wherein the magnetic layer is Co_{A}Pt_{B}Cr_{C}B_{D}O_{X}.

7. A magnetic recording medium according to claim 2 wherein the magnetic layer is Co_{A}Pt_{B}Cr_{C}Nb_{D}O_{X}.

8. A magnetic recording medium according to claim 1 wherein the amount of exchange is 20% to 50% of Hₖ.

9. A magnetic recording medium according to claim 1, further including a soft magnetic underlayer between the substrate and magnetic layer.

10. A magnetic recording medium for a perpendicular recording system, comprising:
a non-magnetic substrate, a magnetically soft under layer, and a magnetic layer having a granular structure comprising ferromagnetic crystalline grains surrounded by an oxide grain boundary, where an amount of exchange field, Hₑₓ, between the ferromagnetic crystalline grains is 20% to 50% of Hₖ, and where Hₖ is a magnetic anisotropy field of the magnetic grains; and wherein
at least one of the layers comprises a plurality of layers.

11. A magnetic recording medium according to claim 10 wherein the magnetic layer is Co_{A}Pt_{B}Cr_{C}M_{D}O_{X} where M is an oxide forming element,

12. A magnetic recording medium according to claim 11 wherein the magnetic layer is Co_{A}Pt_{B}Cr_{C}Si_{D}O_{X}.

13. A magnetic recording medium according to claim 11 wherein the magnetic layer is Co_{A}Pt_{B}Cr_{C}Ta_{D}O_{X}.

14. A magnetic recording medium according to claim 11 wherein the magnetic layer is Co_{A}Pt_{B}Cr_{C}Ti_{D}O_{X}.

15. A magnetic recording medium according to claim 11 wherein the magnetic layer is Co_{A}Pt_{B}Cr_{C}B_{D}O_{X}.

16. A magnetic recording medium according to claim 11 wherein the magnetic layer is Co_{A}Pt_{B}Cr_{C}Nb_{D}O_{X}.

17. A method for measuring magnetic exchange coupling of a material including the steps of:
measuring a major hysteresis loop and a set of recoil loops and generating data for field difference curves between the major hysteresis loop and a set of recoil loops;
fitting the difference curves to a function to generate at least one parameter; and
determining the intergranular exchange coupling field from the at least one parameter.

18. The method of claim 17, wherein the at least one parameter is Jc.

19. The method of claim 17, wherein the determining step also uses σHₖ.

20. The method of claim 17, wherein σHk is determined by a transverse susceptibility measurement.

21. The method of claim 17, wherein the determining step uses at least two parameters.

22. The method of claim 17, wherein the difference curves are ΔH(M).

23. The method of claim 21, wherein the parameters include Jc and σHk.

24. The method of claim 15, wherein the at least one parameter includes asymmetry of an anisotropy field distribution.

25. The method of claim 24, wherein the determining step uses a plurality of parameters and wherein at least one of the plurality of parameters alters the shape of the anisotropy distribution function.

26. A method for measuring magnetic exchange coupling of a material including the steps of:
measuring ΔH(M);
fitting data to obtain σHₖ and J_{c} based on the measurement ΔH(M); and
determining Hₑₓ/Hₖ from the function J_{c}=J(M, σHₖ, Hₑₓ/Hₖ).
